(19) United States
(12) Patent Application Publication
(10) Pub. No.: US 2013/0006888 A1
(43) Pub. Date: Jan. 3, 2013

(54) Autotagging Business Processes

(75) Inventors: Yossi Mesika, Afula (IL); Haggai Roitman, Yokneam Elit (IL)

(73) Assignee: International Business Machines Corporation, Armonk, NY (US)

(21) Appl. No.: 13/175,857

(22) Filed: Jul. 3, 2011

(51) Int. Cl. G06Q 10/06

(52) U.S. Cl. 705/348

(57) ABSTRACT

A method of autotagging business processes for monitoring analysis of an IT system within an organization is provided herein. The method includes the following stages: modeling an IT system associated with one or more business processes, into a model representing the business processes as process instances; tracking a flow of information entities throughout nodes located along the process instances; extracting, at each one of the nodes, metadata associated with each one of the information entities flowing through the process instance; aggregating over time, the extracted metadata being associated with its respective node and process instance; and visually representing the aggregated metadata in association with its respective business processes, based on the model.

### BACKGROUND

1. Technical Field

The present invention relates to analyzing the data flow in organizational IT systems and more particularly, to analyzing business processes of the organization based on the data flow.

2. Discussion of the Related Art

As organizational business processes turn more complex, it becomes ever more challenging to track and analyze these processes within the organization. IT systems that support business processes within an organization are characterized by a structured flow of information entities (e.g., documents) along various process instances, through which a variety of human observers may further carry out tasks in relation with the information entities, until the business process is completed.

In order to ease the handling of the business process, some metadata is associated with the information entities, partly to facilitate the tasks of the human observers and partially to provide visibility and control over the business process a whole. Currently, several software tools are known to mark the information entities as they flow from one instance to another along the business processes, in order to provide some monitoring capabilities that may be later be used by the management to analyze the business processes.

### BRIEF SUMMARY

One aspect of the present invention provides a method of autotagging business processes for monitoring and analysis of an IT system within an organization. The method includes the following stages: modeling an IT system associated with one or more business processes, into a model representing the business processes as a process instances; tracking a flow of information entities throughout nodes located along the process instances; extracting, at each one of the nodes, metadata associated with each one of the information entities flowing through the process instance; aggregating over time, the extracted metadata being associated with its respective node and process instance; and finally, visually representing the aggregated metadata in association with its respective business processes, based on the model.

Other aspects of the invention may include a system arranged to execute the aforementioned method and a computer readable program configured to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an exemplary system according to some embodiments of the invention;

FIG. 2 is a high level flowchart illustrating an exemplary method according to some embodiments of the invention;

FIG. 3 is a diagram illustrating an aspect according to some embodiments of the invention; and

FIGS. 4A and 4b are further diagrams illustrating an aspect according to some embodiments of the present invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “business process” as used herein in this application refers to a collection of related, structured activities or tasks that produce a specific service or product for a particular customer or customers, or the organization itself. The business process may require the involvement of one or more human observers who carry out some of the tasks along the business process. The business process may be represented as a sequence of activities.

The term “tag” in the context of online computer systems, as used herein in this application refers a keyword or term assigned to an information entity (such as document or a computer file). This kind of metadata helps describe an item and allows it to be found again by browsing or searching. By aggregating tags one can visualize the data in an informal manner, such as a cloud of tags.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention, in embodiments thereof, uses metadata associated with information entities, to visually annotate (e.g. autotag) the business process along the flow. The metadata used for the visual representation may be either explicit or implicit and may refer to the content of the information entities, their transformation within the business processes, relationships to other information entities and human observers. Thus, embodiments of the present invention provide a method of (possibly informal) documenting this metadata during the lifecycle of the business process instantiations.

Embodiments of the present invention provide the ability to auto-tag business processes using the information entities metadata that flow within the process. The annotation or the tagging may be carried out, for example, by document's tags or by association to human observers that handled the documents during the process. Advantageously, the proposed auto tagging may help to discover hidden metadata about the process lifecycle and may be used for business process optimization, case management, and monitoring purposes.

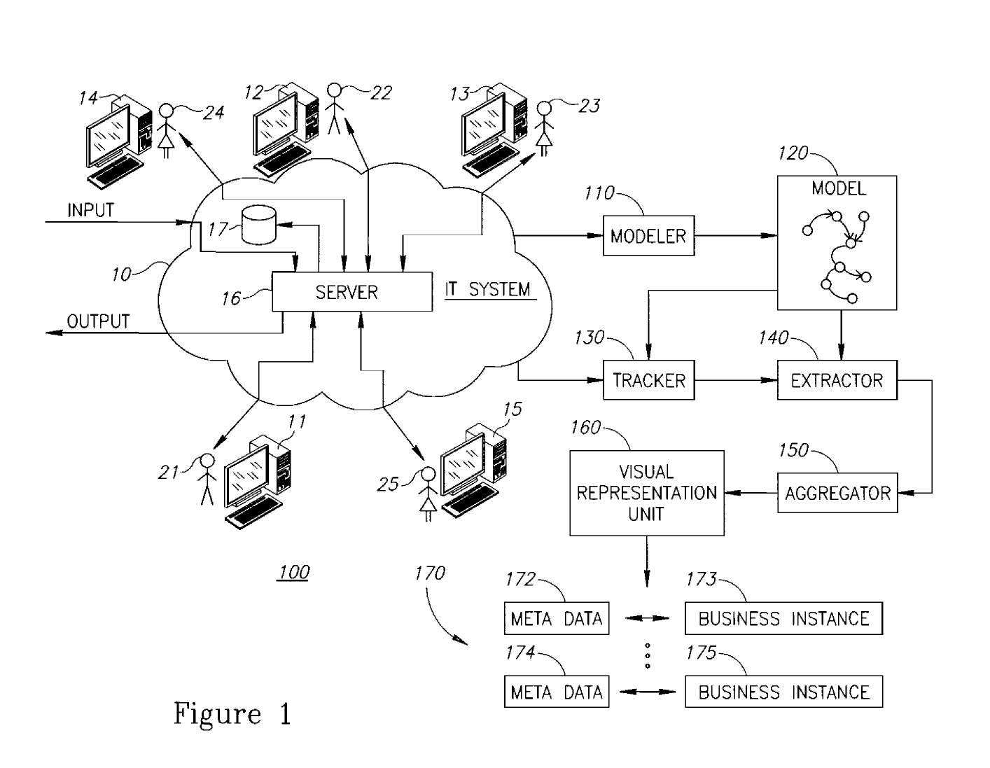

FIG. 1 is a high level schematic block diagram illustrating an exemplary system according to some embodiments of the invention. System 100 may include a modeler 110 and a tracker 130 in operative association with an organizational IT system 10 in which business processes take place. In a proposed non-limiting architecture, system 100 may further include an extractor 140, an aggregator 150 and a visual representation unit 160. IT system 10 may be any computerized system implemented, in a non-limiting example, by a server 16 and at least one database 17, wherein server 16 is connected to a plurality of networked computers 11-15. IT system 10 may be either connected to other systems via input/output or alternatively IT system 10 may be an isolated computerized system.

In operation, modeler 110 may be configured to model a computerized organizational IT system 10 associated with one or more business processes, into a model 120. Model 120 may represent the business processes as process instances. Tracker 130 may be configured to track a flow of information entities (not shown) throughout nodes located along process instance. Extractor 140 may be configured to extract, at each one of the nodes, metadata associated with each one of the information entities flowing through the process instance. Aggregator 150 may be configured to aggregate over time, the extracted metadata being associated with its respective node and process instance. Visual representation unit 160 may be configured to generate a visual representation 170 of the aggregated metadata 172 and 174 in association with its respective business processes 173 and 175, wherein the mapping is based on the model, and possibly over a timeline indicative of the business processes. Visual representation 170 may be presented over a display (not shown) either locally or remotely for monitoring and management purposes.

Consistent with some embodiments of the present invention, IT system 10 may be further associated with human observers 21-25, and wherein aggregator 150 may be further configured to associate any one of human observers 21-25 with their respective nodes and process instances.

Consistent with some embodiments of the present invention, modeler 110 may be further configured to yield a model that comprises at least one directed acyclic graph defined by nodes and edges, wherein the process instance is a flow within the graph along a plurality of nodes wherein the edges represent transitions from one node to another.

Consistent with some embodiments of the present invention, IT system 10 may be associated with an organization that carries out a plurality of processes and sub processes, some of which involve clients, human observers (such as employees of the organization) and client-employees interaction. Specifically, respective metadata may include at least one of the following: client interaction with the organization, internal operations within the organization, external action with the organization, entities other than the organization.

Consistent with some embodiments of the present invention, visual representation unit 160 may further be configured to generate a visual representation that indicates predefined weighing of a priority of each portion of the extracted metadata. The weighing may be indicated by respective size or coloring, or any other graphical means, and may be either predefined or dynamically changing by a user.

Consistent with some embodiments of the present invention, the visual representation unit may be further configured to generate a visual representation indicative of transformations of at least one of the following: metadata, information entity, priority, wherein the transformation is carried out along the flow of each business process. This may provide further insight on the dynamic nature of the data, or information entities of all kinds along the business processes.

Consistent with some embodiments of the present invention, the visual representation unit may further be configured to generate a visual representation that allows navigation through the business processes, indicating aspects of the metadata responsive to user selection. For example, the navigatable representation may be in the form of a tag cloud that provides further visual information responsive to user selection. A user may click on one of the tags or the human observers and in response, interrelations between tags, human observers, processes and the like.

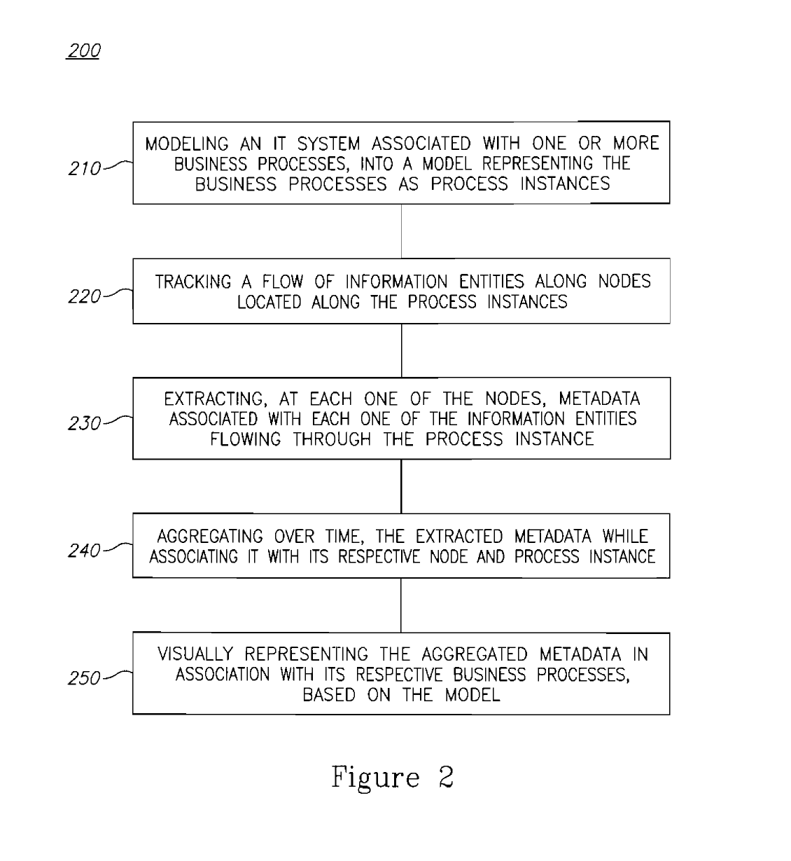

FIG. 2 is a high level flowchart illustrating a method 200 according to some embodiments of the invention. It is understood that method 200 may not be necessarily implemented by the aforementioned architecture of system 100. However, for the sake of clarity, the following steps of method 200 are described in conjunction with components of system 100. Method 200 may start with a step of modeling 210 possibly via modeler 110 an IT system associated with one or more business processes, into a model 120 representing the business processes as process instances. Method 200 then goes on the step of tracking 220 possibly via tracker 130 a flow of information entities along nodes located along the process instances. Then, the method proceeds to a step of extracting 230, possibly via extractor 140 at each one of the nodes, metadata associated with each one of the information entities flowing through the process instance. Then, in an aggregating step 240, the method goes on to aggregating over time, possibly via aggregator 150, the extracted metadata while associating it with its respective node and process instance. Finally, method 200 proceed to the step of visually representing 250, possibly via a display or a visual representation unit 160 the aggregated metadata in association with its respective business processes, based on the model, possibly over a timeline.

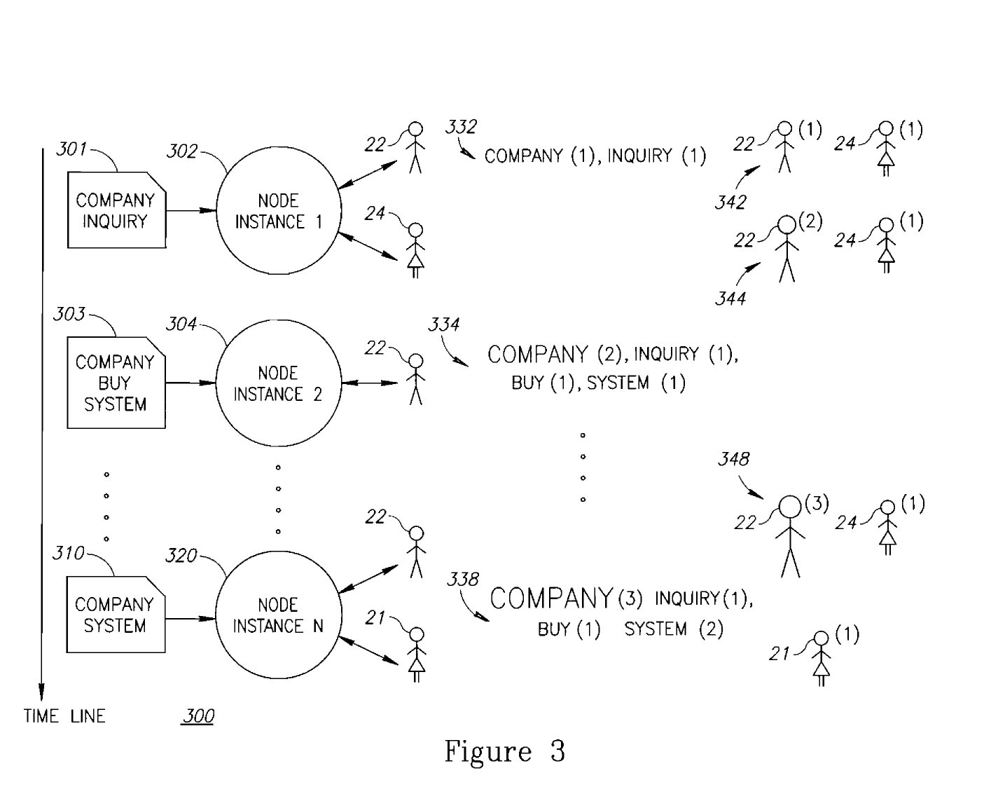

FIG. 3 is a diagram illustrating an aspect according to some embodiments of the invention. A business process in modeled as a process instances that may include nodes 302, 304 . . . 320. Each one of the nodes is respectively associated with metadata 301, 303 . . . 310 indicative in turn of respective information entities (not shown). The metadata may indicate the type of operation carried out at the node (e.g., inquiry, buy) or an organization associated with the operation (e.g., name of company). Additionally, the nodes may further be associated with human observers 21, 22, and 24. After carrying out the stages of the method according to embodiments of the present invention, respective visual representations 332, 334 . . . 338 of the nodes may be presented to a user. In one form, a tag cloud indicative of the accumulated occurrences of the metadata in each node may be presented, with the size indicative of the occurrences. Additionally, the human observers may also be presented similarly to the metadata tags as clouds 342, 344 and 348 with indications as to occurrences by explicit numbers or by size.

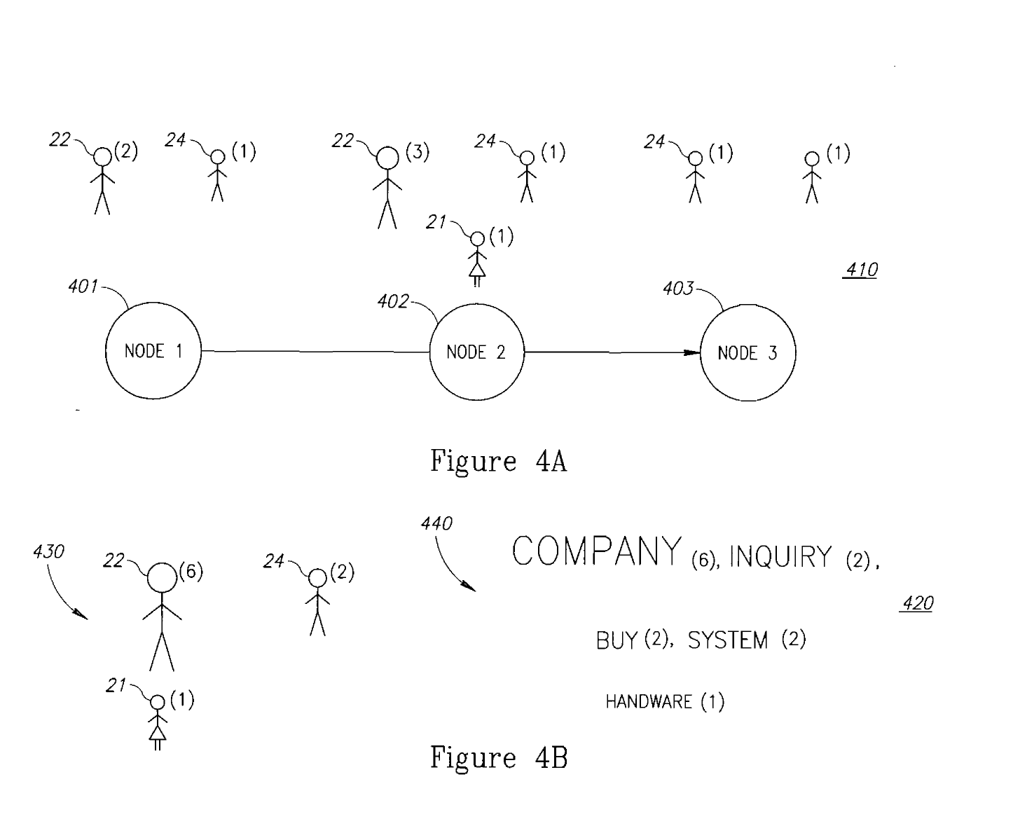

FIG. 4A is another diagram illustrating a modeled flow 410 of process or processes shown as nodes 401-403, each one of the nodes being associated with human observers 21, 22, and 24. FIG. 4B illustrates the two aforementioned forms of visual representation 420 discussed above for the aggregated metadata. Tag cloud 440 shows the tags extracted and aggregated along flow 410 in which size represents occurrence. Additionally and alternatively, the occurrence may also be put in parentheses. Human observers' cloud 430 is also shown. Here, too, size represents occurrences. These clouds, as explained above may be interactive by nature, allowing a user to click on some of the tags/human observers icons thus revealing types of relationships between them and further information illustrative of the nature of data flow within the organization. For example, when a user clicks on some tag in the cloud, the system can show all related process instances from which the user can further zoom into some specific related node.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
modeling an IT system that includes a plurality of networked computers and further associated with one or more business processes, into a model representing the business processes as process instances;
tracking a flow of information entities along nodes located along the process instances;
extracting, at each one of the nodes, metadata associated with each one of the information entities flowing through the process instance;
aggregating over time, the extracted metadata while associating it with its respective node and process instance; and
visually representing the aggregated metadata over a display, in association with its respective business processes, based on the model.

2. The method according to claim 1, wherein the IT system is further associated with human observers, and wherein the aggregating further includes associating the human observers with their respective nodes or process instances.

3. The method according to claim 1, wherein the model comprises at least one directed acyclic graph defined by nodes and edges, wherein the process instance represents a specific flow through a set of nodes and wherein the edges represent transitions from one node to another.

4. The method according to claim 1, wherein the IT system is associated with an organization and wherein the metadata includes at least one of: client interaction with the organization, internal operations within the organization, external action with the organization, entities other than the organization.

5. The method according to claim 1, wherein the visual representation is selected such that it indicates predefined weighing of a priority of each portion of the extracted metadata.

6. The method according to claim 1, wherein the visual representation is indicative of transformations of at least one of: metadata, information entity, priority, along the flow of each business process.

7. The method according to claim 1, wherein the visual representation allows navigation through the business processes, indicating aspects of the metadata responsive to user selection.

8. A system comprising:
a modeler configured to model an IT system that includes a plurality of networked computers and further associated with one or more business processes, into a model representing the business processes as process instances;
a tracker configured to track a flow of information entities along nodes located along the process instance;
an extractor configured to extract, at each one of the nodes, metadata associated with each one of the information entities flowing through the process instance;
an aggregator configured to aggregate over time, the extracted metadata being associated with its respective node and process instance; and
a visual representation unit configured to visually represent the aggregated metadata over a display in association with its respective business processes, based on the model.

9. The system according to claim 8, wherein the IT system is further associated with human observers, and wherein the aggregator is further configured to associate the human observers with their respective node or process instances.

10. The system according to claim 8, wherein the modeler is further configured to yield a model that comprises at least one directed acyclic graph defined by nodes and edges, the process instance represent a specific flow through a set of nodes and wherein the edges represent transitions from one node to another.

11. The system according to claim 8, wherein the IT system is associated with an organization and wherein the metadata includes at least one of: client interaction with the organization, internal operations within the organization, external action with the organization, entities other than the organization.

12. The system according to claim 8, wherein the visual representation unit is further configured to generate a visual representation that indicates predefined weighing of a priority of each portion of the extracted metadata.

13. The system according to claim 8, wherein the visual representation unit is further configured to generate a visual representation indicative of transformations of at least one of: metadata, information entity, priority, along the flow of each business process.

14. The system according to claim 8, wherein the visual representation unit is further configured to generate a visual representation that allows navigation through the business processes, indicating aspects of the metadata responsive to user selection.

15. A computer program product, the computer program product comprising:
a computer readable storage medium having computer readable program embodied therewith, the computer readable program comprising:
computer readable program configured to model an IT system that includes a plurality of networked computers and further associated with one or more business processes, into a model representing the business processes as process instances;
computer readable program configured to track a flow of information entities along nodes located along the process instances;
computer readable program configured to extract, at each one of the nodes, metadata associated with each one of the information entities flowing through the process instance;
computer readable program configured to aggregate over time, the extracted metadata being associated with its respective node and process instance; and
computer readable program configured to visually represent the aggregated metadata over a display, in association with its respective business processes, based on the model.

16. The computer program product according to claim 15, wherein the IT system is further associated with human observers, and wherein the aggregator is further configured to associate the human observers with their respective process instances.

17. The computer program product according to claim 15, wherein the model comprises at least one directed acyclic graph defined by nodes and edges, wherein the nodes represent the process instances and the edges represent transitions from one process instance to another.

18. The computer program product according to claim 15, wherein the IT system is associated with an organization and wherein the metadata includes at least one of: client interaction with the organization, internal operations within the organization, external action with the organization, entities other than the organization.

19. The computer program product according to claim 15, wherein the visual representation indicates predefined weighing of a priority of each portion of the extracted metadata.

20. The computer program product according to claim 15, wherein the visual representation is of transformations of at least one of: metadata, information entity, and priority, all along the flow of each business process.

21. The computer program product according to claim 15, wherein the visual representation allows navigation through the business processes, indicating aspects of the metadata responsive to user selection.
